(19) United States
(12) Patent Application Publication
(10) Pub. No.: US 2006/0158912 A1
(43) Pub. Date: Jul. 20, 2006

(54) Power factor corrector control device for accommodating mains voltage distortion and achieving high power factor and low harmonic current

(76) Inventors: Tsai-Fu Wu, Chia I Hsien (TW); Jiun-Ren Tsai, Tai Nan Hsien (TW); Chih-Lung Shen, Hsin Ying City (TW); Yaow-Ming Chen, Kao Hsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/131,397

(22) Filed: May 18, 2005

(30) Foreign Application Priority Data
Jan. 14, 2005 (TW) 94101180

(51) Int. Cl. H02M 7/04; H02M 5/42

(52) U.S. Cl. 363/89

(57) ABSTRACT

A power factor corrector control device accomplishes control of power factor correction with a simpler and cheaper circuit, overcomes the drawback of higher current harmonics occurred in the prior art, and also accommodates mains voltage distortion. This power factor corrector control device uses a built-in circuit to discriminate the mains frequency, and generates a pure sinusoidal signal having the same frequency with the mains frequency. The product of a feed-forward signal and an output error signal is exploited to get a constant by using a sample-and-hold circuit to determine the amplitude of a reference current signal, hence preventing ripples of the feed-forward signal and the output error signal from generating distortion of the reference current signal after circuit operation. Moreover, a division approximate circuit is used to accomplish simple feed-forward control so as to apply to various different mains voltage levels.

### BACKGROUND OF THE INVENTION

1. Field of the Invention

The present invention relates to a power factor corrector control device for accommodating mains voltage distortion and achieving high power factor and low harmonic and, more particularly, to a power factor corrector control device capable of allowing the input current to be in phase with the mains voltage and also keeping a pure sinusoidal waveform to achieve high power factor and low harmonic when the input mains voltage has distortion and contains voltage harmonics.

2. Description of Related Art

Because the existing electric appliances will produce an input current with high harmonics to an input electric power terminal (mains supply terminal) to deteriorate the quality of electric power, a power factor corrector is thus required for power factor correction and harmonics suppression. Its primary function is to compensate the phase difference between the current generated by an electric appliance and the voltage and to suppress the current harmonics generated by the electric appliance so as to prevent the quality of electric power from being affected. In general, electric power companies prefer connecting a simple resistive load to a power stage circuit than the generation of a high-harmonic current because a high-harmonic current may easily open a circuit breaker to cause disorder of a voltage regulating circuit. A power factor corrector can generally be divided into a power stage and a control stage. FIG. 1 shows the architecture of an electric appliance having a power factor corrector 32, wherein a rectifying circuit 30 converts an input AC mains supply into a DC power source, and a load 34 represents other circuit parts of this electric appliance. Common topologies of the power stage 322 of the power factor corrector 32 include the boost type, the buck type, the flyback type, and so on. Among these architectures, the boost type is most often used in the power factor corrector 32 because it can make use of a single stage circuit to achieve high power factor and lower harmonic. The control stage 324 usually makes use of a feedback output voltage signal, an input current signal, or an input voltage signal to determine a gate signal for driving a power switching component of the power stage. Through high-frequency switching, the input current is forced to follow a reference current signal determined by the waveform of the AC mains voltage, thereby achieving the object of power factor correction.

Today, the UC3854 (or other IC of similar type, e.g., UC3852) is used in the power stage topology of most power factor correctors for control. A control circuit 26 of the UC3854 is shown in FIG. 2. The control circuit 26 comprises three parts: a current mode controller 266, a voltage feedback control stage 264, and a feed-forward control stage 262. The voltage feedback control stage 264 uses an error amplifier EA to compare an output voltage V_{dc} and a reference voltage V_{ref} for getting an output error signal vₑ, and then multiplies the output error signal vₑ by a sinusoidal signal of the input AC mains voltage to get a reference current signal i_{ref}. The current mode controller 266 adjusts the duty cycle of a gate control signal V_{g} of a power switching component Q based on the above reference current signal i_{ref} and the input current signal, thereby forcing the input current to follow the reference current signal i_{ref}. Because this reference current signal i_{ref} is determined by the input AC mains voltage, the input current will follow the AC mains voltage. In the control circuit 26, in order for the power factor corrector of the control circuit 26 to apply to various different mains voltage levels without control of an adjustment knob, the feed-forward control stage 262 makes use of an RC circuit to get a root-mean-squared value of the input AC mains voltage. The output error signal vₑ is then divided by this value squared to adjust the amplitude of the reference current signal so that the output voltage and the input power can be stably controlled in the designed range to have little variation due to change of the input voltage.

In the control circuit 26 of the UC3854, the reference current circuit iref can be represented by:

$${i}_{ref} = \frac{{v}_{e}}{{v}_{rms}^{2}} \times \vert {v}_{line} \vert \qquad ( 1 )$$

where vₑ is the output error signal, v²ᵣₘₛ is the mean-squared value of the mains voltage, and vₗᵢₙₑ is the mains voltage. In (1), because both the output error signal vₑ and the mean-squared value of the mains voltage v²ᵣₘₛ have ripples with twice the mains frequency, harmonic signals not of the same mains frequency will be got after multiplication of these two signals. Therefore, the reference current signal i_{ref} will have harmonics even the mains supply is a pure sinusoidal signal. In existent electric power systems, because feed-in of recyclable energies is more and more common, the waveform of the mains voltage often contains harmonics and thus is not a pure sinusoidal signal. Therefore, the reference current signal i_{ref} will no longer be a pure sinusoidal signal, and the current inputted to the power factor corrector will certainly contain harmonics.

The architecture of a conventional power factor corrector using the UC3854 series for control has the following drawbacks:
1. Ripples of the output signal and the feed-forward signal will cause distortion of the reference current signal so that the input current will contain harmonics.
2. When the input mains supply contains harmonics, the input current will no longer keep a pure sinusoidal waveform and will have high-harmonic components as the input mains supply.
3. The processing circuit of the feed-forward signal is more complex. It must contain a multiplier circuit and a divider circuit. The manufacturing cost and design complexity will be increased.
4. Because the reference current signal is got after the mains supply is rectified by a rectifier, distortion of the reference signal will occur at zero-cross points.

Accordingly, the present invention proposes a power factor corrector control device allowing a power factor corrector to achieve high power factor and low harmonic even when the mains supply has distortion.

### SUMMARY OF THE INVENTION

An object of the present invention is to provide a power factor corrector control device, which can improve the phase difference problem between the voltage and current at the input terminal of a conventional power factor corrector, and can avoid distortion of a reference current signal of the input current of a conventional power factor corrector caused by ripples of the output voltage and the feed-forward signal and distortion of the input mains voltage so that the input current of the conventional power factor corrector will have harmonics. Therefore, the present invention can improve the drawback of deterioration of the quality of electric power caused by a conventional power factor corrector.

Another object of the present invention is to provide a power factor corrector control device, which can discriminate the mains frequency to produce a reference pure sinusoidal signal with the accurate frequency so that the power factor corrector can apply to various different mains frequencies. Moreover, a feed-forward control circuit is used to accomplish feed-forward control of the power factor corrector control device of the present invention so that the power factor corrector can apply to various different mains voltage levels without control of an adjustment knob.

In order to achieve the above objects, the present invention provides a power factor corrector control device, which comprises a voltage feedback control circuit connected to a load end for receiving a feedback voltage signal and outputting a reference current signal after internal processing, and a current feedback control circuit connected to the voltage feedback control circuit and an input terminal of the system circuit for receiving the reference current signal and an input current signal to produce a gate signal for controlling switching of a power switch. Through high-frequency switching of the power switch, the input current is forcedly controlled. The voltage feedback control circuit comprises a sine-wave generating circuit for producing a pure sinusoidal signal to determine the waveform of the reference current signal, and a sample-and-hold circuit (SAH), which samples the product for determining the amplitude of the reference current signal of an output error signal and the feed-forward signal once at the initial stage of a mains period and keeps this sampled value during this mains period. Through the self-generated pure sinusoidal signal and the constant amplitude in a mains period, a reference current signal which is a pure sinusoidal wave in a mains period is generated. Matched with a well-designed current mode controller in the current feedback control circuit, current harmonics generated at the input terminal of the power factor corrector will be reduced to almost none.

In order to achieve the above objects, the present invention also provides a sine-wave generating circuit, which comprises a zero-cross detector for detecting zero-cross points of the input mains voltage, a frequency detector for discriminating the mains frequency, and a sine-wave generator for generating a pure sinusoidal signal. Reference pure sinusoidal signals with different frequencies will thus be generated according to different mains frequencies. The present invention further makes use of an RC circuit in the feed-forward circuit to get the input mains voltage for outputting a feed-forward signal vᵣₘₛ, which is sent to a division approximate circuit connected to the RC circuit. This division approximate circuit is used to output an approximate inverse value 1/vᵣₘₛ of the feed-forward signal vᵣₘₛ. Therefore, when the input voltage is changed, this feed-forward signal can be used to adjust the amplitude of the reference current signal.

### BRIEF DESCRIPTION OF THE DRAWINGS

The various objects and advantages of the present invention will be more readily understood from the following detailed description when read in conjunction with the appended drawing, in which:

FIG. 1 is an architecture diagram of a conventional power factor correction circuit;

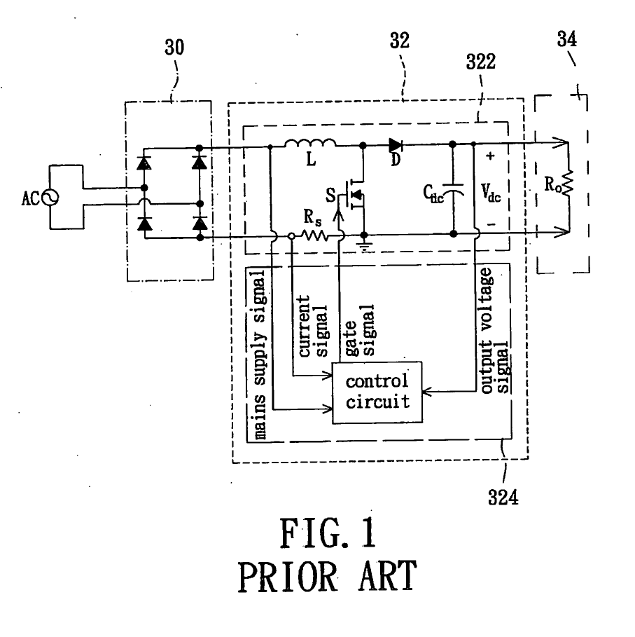

FIG. 2 is an architecture diagram of a conventional power factor corrector control device using UC3854 as the controller;

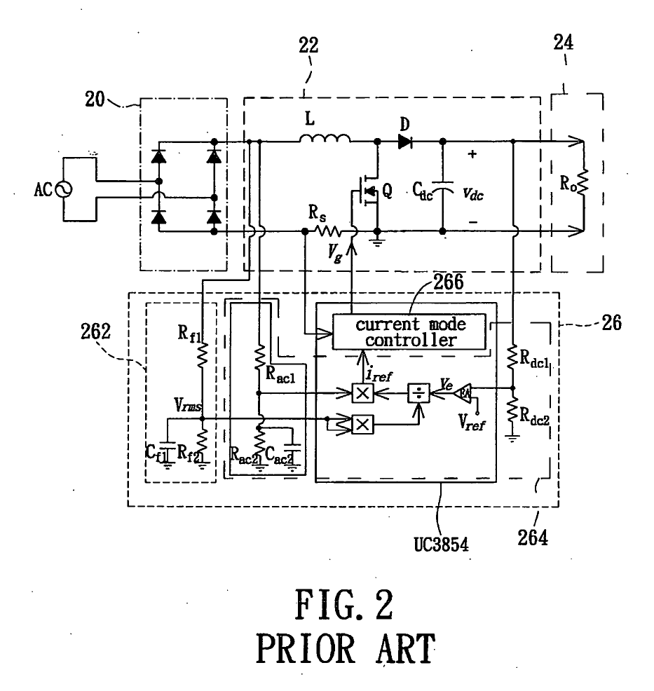

FIG. 3 is a circuit block diagram of a power factor corrector control device for accommodating mains voltage distortion and achieving high power factor and low harmonic of the present invention;

FIG. 4 is a diagram illustrating a division approximate circuit of the present invention; and

FIG. 5 is a waveform diagram showing the operation of FIG. 3.

### DETAILED DESCRIPTION OF THE PREFERRED EMBODIMENTS

The present invention proposes a power factor corrector control device for accommodating mains voltage distortion and achieving high power factor and low harmonic. The present invention is connected to an power input terminal of a power stage circuit for achieving high power factor and low harmonic of the power stage circuit. Its primary function is to get the voltage signal and current signal of the mains supply inputted by the power stage circuit. With also an output voltage signal, an accurate gate control signal of a power switch can be determined. Through high-frequency switching of a power switch, the input current is forced to follow a reference current signal so that the input current of the power stage circuit will have the same phase as the input voltage and also keep a pure sinusoidal waveform. The present invention adopts a control way that can avoid distortion of the reference current signal to accomplish control of the power factor corrector, thereby improving the situation that the current contains harmonics to affect the quality of electric power.

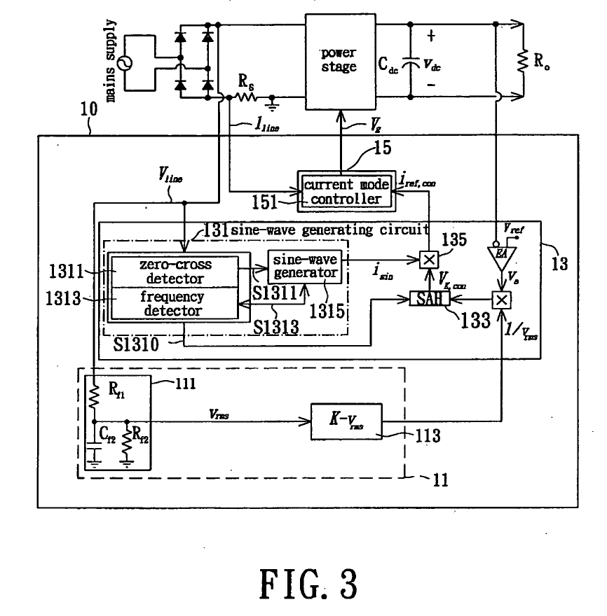

shown in FIG. 3, the present invention provides a power factor corrector control device 10 for accommodating mains voltage distortion and achieving high power factor and low harmonic. The power factor corrector control device 10 comprises a feed-forward control circuit 11, a voltage feedback control circuit 13, and a current feedback control circuit 15. The feed-forward control circuit 11 comprises an RC circuit 111 capable of measuring a root-mean-squared signal vᵣₘₛ of the mains voltage and a division approximate circuit 113 for performing inverse operation of the root-mean-squared signal vᵣₘₛ. The division approximate circuit 113 can get an inverse signal 1/vᵣₘₛ of the root-mean-squared value of the mains voltage. When the root-mean-squared signal vᵣₘₛ fed back to the mains voltage is the feed-forward signal used to cancel out the influence to the output voltage v_{dc} caused by the variation of the mains voltage, variation of the input voltage only influences the output voltage (i.e., the amplitude of the reference current signal i_{ref,con}) but doesn't influence the waveform of the reference current (since this part is the unit pure sinusoidal waveform built in the controller), it is only necessary to divide the output error signal vₑ by the feed-forward signal vᵣₘₛ. For IC fabrication, however, the fabrication cost of a divider will much larger than that of a multiplier. Therefore, the present invention makes use of the division approximate circuit to get the inverse 1/vᵣₘₛ of the feed-forward signal, and then multiplies the output error signal vₑ by this value to obtain the same result of dividing the output error signal vₑ by the feed-forward signal vᵣₘₛ. The voltage feedback control circuit 13 has a sine-wave generating circuit 131, which comprises a zero-cross detector 1311 for detecting zero-cross points of the mains voltage signal, a frequency detector 1313 for discriminating the frequency (e.g., 50 or 60Hz) of the mains voltage signal, and a sine-wave generator 1315 for generating a pure sinusoidal signal iₛᵢₙ having the same frequency and phase with the mains voltage signal based on signals sent out by the zero-cross detector 1311 and the frequency detector 1313. The zero-cross detector 1311 and the frequency detector 1313 constitute a mains supply signal detection circuit used to detect zero-cross points and the frequency of the mains voltage signal for outputting a zero-cross detection signal S1311 and a frequency detection signal S1313.

The pure sinusoidal signal iₛᵢₙ will determine the waveform of the reference current signal i_{ref,con}. An error amplifier EA whose function is to amplify the error between the output voltage v_{dc} and a reference voltage v_{ref} is also provided. This error is called the output error signal vₑ. This output error signal vₑ multiplied by the inverse 1/vᵣₘₛ of the feed-forward signal will be used to determine the amplitude of the reference current signal i_{ref,con}. In order to avoid distortion of the reference current signal i_{ref,con} caused by ripples of the output voltage and the feed-forward voltage, the present invention makes use of a sample-and-hold circuit (SAH) 133 to get a trigger signal outputted by the voltage feedback control circuit 13 to sample a mains period once and then hold the sampled value during the mains period. The product V_{k,con} of the output error signal vₑ and the inverse 1/ᵣₘₛ of the feed-forward signal for determining the amplitude of the reference current signal i_{ref,con} will thus keep constant in a mains period. This value V_{k,con} is an amplitude adjustment signal. Moreover, a multiplier 135 connected to the sine-wave generating circuit 131 and the SAH 133 is used to receive the pure sinusoidal signal iₛᵢₙ and the amplitude adjustment signal V_{k,con} and then output the reference current signal i_{ref,con} after multiplication operation.

In the present invention, the reference current signal i_{ref,con} can be expressed as follows:

$${i}_{ref . con} = {V}_{k , con} \times \vert sin ω t \vert \qquad ( 2 )$$

wherein the amplitude adjustment signal V_{k,con} is the product of the output error signal vₑ and the inverse 1/vᵣₘₛ of the feed-forward signal sampled by the SAH 133 (V_{k,con} is a constant in a mains period), sin ωt is the pure sinusoidal signal iₛᵢₙ generated by the sine-wave generating circuit 131 and having the same phase and frequency as the mains voltage, and ω is the frequency of the mains voltage. In the control circuit 10 of the present invention, the reference current signal i_{ref,con} won't be affected by other signals to have distortion, and will keep a pure sinusoidal waveform in each mains period.

The current feedback control circuit 15 has a current mode controller 151, which is connected to the power stage circuit and the voltage feedback control circuit and used for getting a mains current signal Iₗᵢₙₑ and the reference current signal i_{ref,con} and controlling switching of a power switch component of the power stage circuit to adjust the duty cycle of a gate control signal V_{g} of the power switch component. Through controlling the gate control signal V_{g} of the power switch component to switch the power switch component in a high frequency, the mains current signal Iₗᵢₙₑ is forced to follow the waveform of the reference current signal i_{ref,con} so as to accomplish the object of controlling the mains current signal Iₗᵢₙₑ. Because the reference current signal i_{ref,con} is a pure sinusoidal signal having the same phase and frequency as the input mains voltage signal, the current feedback control circuit 15 will make the mains current signal Iₗᵢₙₑ a pure sinusoidal signal having the same phase and frequency as the input mains voltage signal vₗᵢₙₑ. Therefore, the power factor corrector control device of the present invention can easily achieve high power factor and low harmonic.

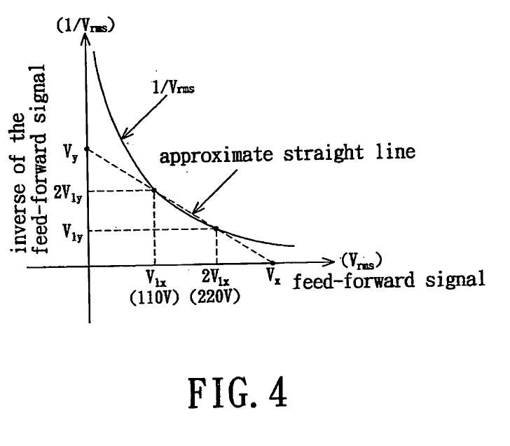

The principle of the division approximate circuit 113 is shown in FIG. 4. Because the curve of the inverse 1/vᵣₘₛ of the feed-forward signal between points V₁ₓ(110) and 2V₁ₓ(220V) is close to a dotted approximate line shown in FIG. 4, only a subtractor and a multiplier are required for accomplishing the function of division operation by means of straight-line approximation. In FIG. 4, V₁ₓ and 2V₁ₓ are the inverses of the root-mean-squared value vᵣₘₛ of the mains voltage signal obtained by the RC circuit 111 when the mains voltage signal is at 110V and 220V, respectively, and Vₓ and V_{y} are the intersects of the approximate line designed based on V₁ₓ, 2V₁ₓ, V_{1y}, and 2V_{1y} with the x- and y-axes, respectively. In straight-line approximation, the inverse 1/vᵣₘₛ of the feed-forward signal can be expressed as K(C-vᵣₘₛ), wherein C is a constant designed by the user or directly defined in IC design. Besides, K can also be incorporated into design of the operating point of the output error signal. Vₑ/vᵣₘₛ can thus have the same effect as vₑ×K(C-vᵣₘₛ), as shown in the following equation:
vₑ/vᵣₘₛ=vₑ×K(C−vᵣₘₛ)=(Kvₑ)×(C-vᵣₘₛ) (3)
wherein vₑ is the output error signal, vᵣₘₛ is the root-mean-squared value of the input mains voltage signal, and K and C are constants designed by the user. Kvₑ is the output error signal of a newly designed operating point based on the K value. Therefore, the K and C values can be designed according to user's requirements.

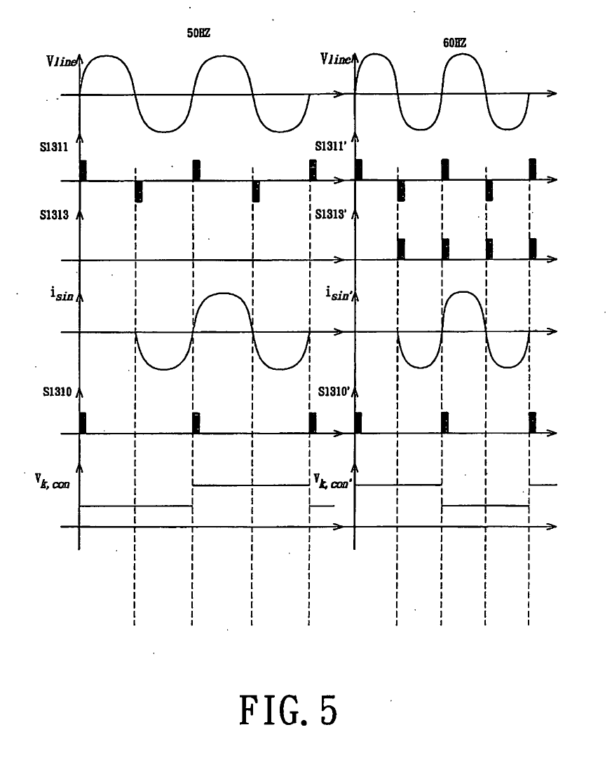

Please refer to FIG. 5 as well as FIG. 3. The zero-cross detector 1311 will send out the zero-cross detection signal S1311 or S1311′ at each zero-cross point of the mains voltage signal vₗᵢₙₑ or vₗᵢₙₑ′. The frequency detection signal 1313 will send out the frequency detection signal S1313 only when receiving the mains voltage signal of 60 Hz (or close to 60 Hz). The sine-wave generator 1315 starts to send out a pure sinusoidal signal iₛᵢₙ or iₛᵢₙ′ at the second half (the positive or negative half cycle of the mains voltage signal) of the mains period after finishing the determination of the frequency of the mains voltage signal. Moreover, a sample-and-hold activation signal S1310 or S1310′ of the SAH 133 is controlled by the zero-cross detection signal S1311 or S1311′. In the positive half-cycle of each mains period, the sample-and-hold activation signal S1310 or s1310′ is activated, and the sampled signal is held constant in each mains period. In FIG. 5, the SAH 133 samples the amplitude adjustment signal V_{k,con} or V_{k,con}′. The waveforms shown in FIG. 5 only illustrate the actions of each important circuit and may be different from real waveforms.

To sum up, the power factor corrector control device of the present invention has the following characteristics:
1. Influence of ripples of the output signal and feed-forward signal to the reference current signal can be eliminated to make the input current a pure sinusoidal signal having no harmonic.
2. The input current can still keep pure sinusoidal even the input mains supply contains harmonics. In other words, the input current contains no harmonics at any situation.
3. The processing circuit of the feed-forward signal is simplified, and a divider required by conventional feed-forward processing is replaced with a division approximate circuit to lower the IC fabrication cost and design complexity.
4. The self-generated sinusoidal signal of the sine-wave generating circuit can avoid distortion at zero-cross points.
5. The present invention applies to power factor corrector circuits of various different circuit architectures.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A power factor corrector control device for accommodating mains voltage distortion and achieving high power factor and low harmonic, said power factor corrector control device being connected to a power input terminal of a power stage circuit for controlling said power stage circuit to achieve high power factor and low harmonic, said power factor corrector control device comprising:
a voltage feedback control circuit connected to an input terminal and an output terminal of said power stage circuit for respectively getting a mains voltage signal and an output voltage and outputting a reference current signal for voltage feedback control, said voltage feedback control circuit comprising:
a sine-wave generating circuit for getting said mains voltage signal to generate a pure sinusoidal signal;
an error amplifier for receiving said output voltage and a reference voltage and then outputting an output error signal after comparing said output voltage and said reference voltage;
a sample-and-hold circuit for receiving a trigger signal of said voltage feedback control circuit to activate the sample-and-hold function so as to output an amplitude modulation signal;
a multiplier connected to said sine-wave generating circuit and said sample-and-hold circuit for receiving said pure sinusoidal signal and said amplitude modulation signal and also outputting said reference current signal after multiplication operation;
a feed-forward control circuit connected to said power stage circuit and said voltage feedback control circuit for receiving said mains voltage signal to output an inverse of a feed-forward signal; and
a current feedback control circuit connected to said power stage circuit and said voltage feedback control circuit for getting a mains current signal and said reference current signal to output a control signal for controlling switching of said power stage circuit;
whereby said sample-and-hold circuit samples and holds the product of said output error signal and said feed-forward signal and then adjusts the amplitude of said pure sinusoidal signal through said multiplier so as to output said reference current signal.

2. The power factor corrector control device for accommodating mains voltage distortion and achieving high power factor and low harmonic as claimed in claim 1, wherein said current feedback control circuit comprises a current mode controller for determining said control signal so that the input current of said power stage circuit can follow said reference current signal.

3. The power factor corrector control device for accommodating mains voltage distortion and achieving high power factor and low harmonic as claimed in claim 1, wherein said sine-wave generating circuit comprises:
a zero-cross detector for detecting zero-cross points of said mains voltage signal;
a frequency detector for discriminating the frequency of said mains voltage signal; and
a sine-wave generator for generating said pure sinusoidal signal having the same frequency and phase with said mains voltage signal.

4. The power factor corrector control device for accommodating mains voltage distortion and achieving high power factor and low harmonic as claimed in claim 1, wherein said sample-and-hold circuit samples the product of said output error signal and the inverse of said feed-forward signal according to said trigger signal, and holds the sampled value until the next sampling.

5. The power factor corrector control device for accommodating mains voltage distortion and achieving high power factor and low harmonic as claimed in claim 1, wherein said feed-forward control circuit comprises:
an RC circuit for getting a root-mean-squared value of said mains voltage signal; and
a division approximate circuit connected to said RC circuit for receiving said root-mean-squared value to output an inverse of said root-mean-squared, said root-mean-squared value being said feed forward signal.

6. A power factor corrector control device for accommodating mains voltage distortion and achieving high power factor and low harmonic, said power factor corrector control device being connected to a power input terminal of a power stage circuit for controlling said power stage circuit to achieve high power factor and low harmonic, said power factor corrector control device comprising:
a mains supply signal detection circuit connected to a power input terminal of said power stage circuit for detecting zero-cross points and the frequency of a mains voltage signal to output a zero-cross detection signal and a frequency detection signal;
a sine-wave generator connected to said mains supply signal detection circuit for receiving said zero-cross detection signal and said frequency detection signal to output a pure sinusoidal signal having the same frequency and phase with said mains voltage signal;
an error amplifier connected to an output terminal of said power stage circuit for receiving an output voltage and a reference voltage and then outputting an output error signal after comparing said output voltage and said reference voltage;
an RC circuit connected to said power input terminal of said power stage circuit for receiving said mains voltage signal to output a root-mean-squared value of said mains voltage signal;
a division approximate circuit connected to said RC circuit and said error amplifier for receiving said root-mean-squared value of said mains voltage signal as a feed-forward signal and then outputting an inverse of said root-mean-squared;
a sample-and-hold circuit for receiving a trigger signal outputted by said mains supply signal detection circuit to sample and hold the product of said output error signal and the inverse of said feed-forward signal so as to output an amplitude modulation signal;
a multiplier connected to said sine-wave generator and said sample-and-hold circuit for receiving said pure sinusoidal signal and said amplitude modulation signal and also outputting said reference current signal after multiplication operation; and
a current mode controller connected to said power stage circuit and said multiplier for getting a mains current signal and said reference current signal to output a control signal for controlling switching of said power stage circuit so that the input current of said power stage circuit can follow said reference current signal.

7. The power factor corrector control device for accommodating mains voltage distortion and achieving high power factor and low harmonic as claimed in claim 6, wherein said mains supply signal detection circuit comprises:
a zero-cross detector for detecting zero-cross points of said mains voltage signal; and
a frequency detector for detecting the frequency of said mains voltage signal.

8. The power factor corrector control device for accommodating mains voltage distortion and achieving high power factor and low harmonic as claimed in claim 6, wherein said sample-and-hold circuit samples the product of said output error signal and the inverse of said feed-forward signal according to said trigger signal, and holds the sampled value until the next sampling.

9. A power factor corrector control device for accommodating mains voltage distortion and achieving high power factor and low harmonic, said power factor corrector control device being connected to a power input terminal of a power stage circuit for controlling said power stage circuit to achieve high power factor and low harmonic, said power factor corrector control device comprising:
a sine-wave generating circuit connected to the input terminal of said power stage circuit for receiving a mains voltage signal to generate a pure sinusoidal signal having the same frequency and phase with said mains voltage signal;
a feed-forward control circuit connected to the input terminal of said power stage circuit for receiving said mains voltage signal to perform feed-forward control and output an inverse of a feed-forward signal
a sample-and-hold circuit for receiving a trigger signal to sample and hold the product of an output error signal and said feed-forward signal so as to output an amplitude modulation signal;
a multiplier connected to said sine-wave generating circuit and said sample-and-hold circuit for receiving said pure sinusoidal signal and said amplitude modulation signal and also outputting a reference current signal after multiplication operation; and
a current feedback control circuit connected to said power stage circuit and said sample-and-hold circuit for getting a mains current signal and said reference current signal to output a control signal for controlling switching of said power stage circuit so that the input current of said power stage circuit can follow said reference current signal.

10. The power factor corrector control device for accommodating mains voltage distortion and achieving high power factor and low harmonic as claimed in claim 9, wherein said sample-and-hold circuit samples the product of said output error signal and the inverse of said feed-forward signal according to said trigger signal, and holds the sampled value until the next sampling.

11. The power factor corrector control device for accommodating mains voltage distortion and achieving high power factor and low harmonic as claimed in claim 10, wherein an error amplifier is used to amplify the difference value between an output voltage and a reference voltage signal to get said output error signal.

12. The power factor corrector control device for accommodating mains voltage distortion and achieving high power factor and low harmonic as claimed in claim 9, wherein said feed-forward control circuit comprises:
an RC circuit for getting a root-mean-squared value of said mains voltage signal; and
a division approximate circuit connected to said RC circuit for receiving said root-mean-squared value to output an inverse of said root-mean-squared, said root-mean-squared value being said feed forward signal.
